(19) United States
(12) Patent Application Publication
(10) Pub. No.: US 2012/0317278 A1
(43) Pub. Date: Dec. 13, 2012

(54) COMMUNICATION APPARATUS, COMMUNICATION METHOD AND REMOTE MONITORING SYSTEM

(75) Inventors: Satoshi TAMAKI, Yokohama (JP); May TAKADA, Kawasaki (JP); Shoji YUNOKI, Fujisawa (JP)

(73) Assignee: HITACHI, LTD., Tokyo (JP)

(21) Appl. No.: 13/488,895

(22) Filed: Jun. 5, 2012

(30) Foreign Application Priority Data
Jun. 8, 2011 (JP) 2011-128012

(51) Int. Cl. G06F 15/173

(52) U.S. Cl. 709/224

(57) ABSTRACT

In a remote monitoring system including a monitoring center, a sensing information collecting station, and one or more sensing terminals, the sensing information collecting station collects measurement results measured by the sensing terminals, classifies the collected measurement results into priority information and general information, and transmits priority information and general information to the monitoring center. The monitoring center transmits response information to received priority information to the sensing information collecting station. The sensing information collecting station estimates network condition from a delay time based on the response information and decreases the transmission rate of general information when the estimated network condition is more congested. Thereby, even if the network condition fluctuates, desired information such as statistical information on measurement results and measurement results meeting a predetermined condition is communicated stably at low delay.

### CLAIM OF PRIORITY

The present application claims priority from Japanese patent application JP 2011-128012 filed on Jun. 8, 2011, the content of which is hereby incorporated by reference into this application.

### FIELD OF THE INVENTION

The present invention relates to a communication apparatus, communication method, and remote monitoring system and, particularly, to a communication apparatus, communication method, and remote monitoring system using a network operating in a fluctuating communication environment for radio communication or the like.

### BACKGROUND OF THE INVENTION

Lately, a remote monitoring system is widespread in which measurement results measured by various sensors are monitored at a monitoring center via a network. To carry out remote monitoring, it is not only necessary to communicate measurement results measured by sensors, which may come to a large amount of data, but also a stable reduction in communication delay is needed so that the monitoring center can instantly respond to an event occurred in an object under monitoring.

In order to reduce communication delay, a priority control method comprising setting a priority level per communication packet such that, for example, a packet for communication that requires a low delay is given a high priority level and reordering packets in order of priority in a network node is known and various methods are proposed. A technique in which a router apparatus, based on the priority level and discard tolerance of a packet, determines a priority level of processing the packet and whether the packet is to be discarded when congestion occurs is disclosed, e.g., in Japanese Unexamined Patent Application Publication No. Hei 7 (1995)-135512 which is hereinafter referred to as Patent Document 1.

### SUMMARY OF THE INVENTION

Network congestion that is experienced by an apparatus occurs when the rate at which signals are input to the apparatus has exceeded the rate at which signals are output from the apparatus. If the apparatus has a buffer, signals are stored into the buffer at a rate corresponding to a difference between the output signal rate and the input signal rate and the signals will delay in proportion to the amount of signals stored in the buffer. The priority control suggested in Patent Document 1 and others alleviates the influence of delay caused by the buffer by preferentially processing a packet that requires a low delay.

By the way, because the technique described in Patent Document 1 is applied in a router apparatus, determining a priority level of a packet and a packet to be discarded is performed on a per IP packet basis. Therefore, that technique can alleviate the influence of the buffer on an IP layer, but cannot alleviate the influence of the buffer on a lower layer.

Meanwhile, in cases where radio communication is used on a physical layer of a network, a large buffer is typically used to absorb a large fluctuation in communication rate, which is specific to radio communication. However, there is such a problem that this large buffer accumulates signals, which may cause a large delay in some situations, and this delay cannot be alleviated by the priority control according to, e.g., the technique described in Patent Document 1.

In order to address the problems noted above, the present invention is intended to provide a communication apparatus, communication method, and remote monitoring system that allow for a stable reduction in delay for packets that require a low delay even in a case where a network undergoing a large fluctuation is used in the remote monitoring system.

In order to address the diverse problems noted above, a remote monitoring system of the present invention includes a monitoring center, a sensing information collecting station connected to the monitoring center via a network, and one or more sensing terminals connected to the sensing information collecting station via a network. The sensing information collecting station collects measurement results measured by the one or more sensing terminals and classifies the collected measurement results into priority information and general information, and the sensing information collecting station transmits the priority information and the general information to the monitoring center. The monitoring center transmits response information to the received priority information to the sensing information collecting station. One feature resides in that the sensing information collecting station estimates network condition based on the response information and decreases the transmission rate of the general information when the estimated network condition is more congested.

According to one aspect of the present invention, there is provided a communication apparatus that transmits sensing information measured by sensing terminals and/or statistical information based on the sensing information to a monitoring apparatus via a network, the communication apparatus including:

a classification unit that classifies sensing information measured by the sensing terminals and/or statistical information based on the sensing information into first information and second information;

a first information transmitting unit that transmits first information to the monitoring apparatus;

a delay time obtaining unit that measures a delay time to reach first information to the monitoring apparatus across the network or to reach first information across a section of the network or receives the delay time measured by another apparatus;

a rate control block that determines a transmission data rate of second information depending on the delay time, so that the transmission data rate of second information should become smaller when the delay time is larger; and

a second information transmitting unit that transmits second information according to the transmission data rate determined by the rate control block.

According to another aspect of the present invention, there is provided a communication method in a system where sensing information measured by sensing terminals and/or statistical information based on the sensing information is transmitted to a monitoring apparatus via a network, the communication method including the steps of:

classifying sensing information measured by sensing terminals and/or statistical information based on the sensing information into first information and second information;

transmitting first information to the monitoring apparatus;

measuring a delay time to reach first information to the monitoring apparatus across the network or to reach first information across a section of the network or receiving the delay time measured by another apparatus;

determining a transmission data rate of second information depending on the delay time, so that the transmission data rate of second information should become smaller when the delay time is larger; and

transmitting second information according to the determined transmission data rate.

According to still another aspect of the present invention, there is provided a remote monitoring system including:

a network communication apparatus that collects and transmits sensing information measured by sensing terminals; and

a monitoring apparatus that receives the sensing information and/or statistical information based on the sensing information from the network communication apparatus via a network,

the network communication apparatus including:

a classification unit that classifies sensing information from the sensing terminals and/or statistical information based on the sensing information into first information and second information;

a first information transmitting unit that transmits first information to the monitoring apparatus;

a delay time obtaining unit that measures a delay time to reach first information from the network communication apparatus to the monitoring apparatus across the network or to reach first information across a section of the network or receives the delay time measured by another apparatus;

a rate control block that determines a transmission data rate of second information depending on the delay time, so that the transmission data rate of second information should become smaller when the delay time is larger; and

a second information transmitting unit that transmits second information according to the transmission data rate determined by the rate control block.

According to the aspects of the present invention, it is possible to provide a communication apparatus, communication method, and remote monitoring system that allow for a stable reduction in delay for packets that require a low delay even in an environment where the communication rate largely fluctuates, for example, in a case where radio communication is used on a network physical layer of the remote monitoring system.

### BRIEF DESCRIPTION OF THE DRAWINGS

FIG. 1 is an overall structural diagram of a remote monitoring system according to embodiments described herein.

FIG. 2 shows an example of a sequence in the remote monitoring system according to a first embodiment.

FIG. 3 shows an example of transmission signal information according to embodiments described herein.

FIG. 4 shows an example of a functional block diagram of a sensing information collecting station of the first embodiment.

FIG. 5 is a graph showing an example of a relationship between delay time and general information transmission rate.

FIG. 6 shows an example of a sequence in the remote monitoring system according to a second embodiment.

FIG. 7 shows an example of a functional block diagram of a sensing information collecting station of the second embodiment.

FIG. 8 shows an example of a sequence in the remote monitoring system according to a third embodiment.

FIG. 9 shows an example of a functional block diagram of a router of the third embodiment.

FIG. 10 shows an example of a sequence in the remote monitoring system according to a fourth embodiment.

FIG. 11 shows an example of a functional block diagram of a router of the fourth embodiment.

FIGS. 12A and 12B show examples of transmission control signals according to embodiments described herein.

FIG. 13 is a schematic diagram representing an order of information signals which are input from respective signal transmitting units to a network interface, according to embodiments described herein.

FIG. 14 shows an example of a functional block diagram of a monitoring center of the second embodiment.

FIG. 15 is a diagram showing an example of a structure of a component apparatus, configured mainly with DSP and CPU, of the respective embodiments.

FIG. 16 is a diagram showing an example of a hardware structure of the sensing information collecting station.

FIG. 17 is a diagram showing an example of a hardware structure of the monitoring center.

FIG. 18 is a diagram showing an example of a hardware structure of a router.

FIG. 19 is a diagram showing an example of a hardware structure of a router according to the fourth embodiment.

### DETAILED DESCRIPTION OF THE PREFERRED EMBODIMENTS

In the following, various embodiments of the present invention will be described in accordance with the drawings.

### 1. First Embodiment

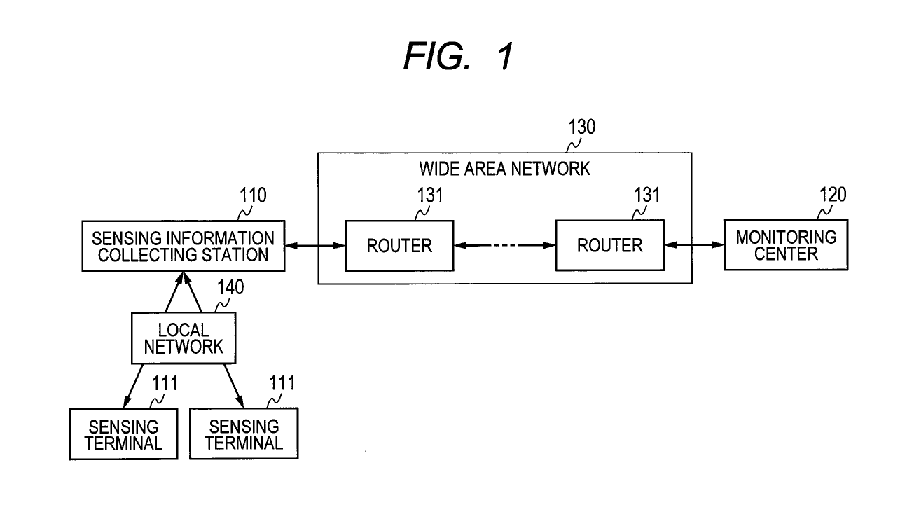

FIG. 1 depicts an overall structural diagram of a remote monitoring system.

The remote monitoring system according to embodiments described herein includes a sensing information collecting station (network communication apparatus, communication apparatus, or sensing information collecting station) 110 and a monitoring center (monitoring apparatus) 120 which are connected via, for example, a wide area network 130 and one or more sensing terminals 111 which are connected to the sensing information collecting station 110 via a local network 140. The wide area network 130 includes one or more routers (forwarding apparatuses or communication apparatuses) 131.

A sensing terminal 111 has a sensor function and a local network communication function. A sensing terminal 111 makes a measurement using the sensor function and sends sensor sensing information obtained as a result of the measurement to the sensing information collecting station 110 via the local network 140. Here, the sensor function refers to any of or a combination of the following: a sensor that is operable independently, such as, e.g., a temperature sensor, a humidity sensor, and an acceleration sensor; a sensor using external signal input such as a GPS-based location sensor; and a monitoring device that acquires audio and still or moving images. A sensing terminal 111 may have a function that changes the operation of either or both of the sensor function and the local network communication function according to control from the sensing information collecting station 110. Here, what is changed is, for example, a sensor type used for measurement in the sensor function, a measurement frequency in the sensor function, or a communication frequency in the local network communication function.

The sensing information collecting station 110 has a communication function with the monitoring center 120 via the network 130 and a communication function with the one or more sensing terminals 111 via the local network 140. The sensing information collecting station 110 has a function that collects sensor sensing information sent from the one or more sensing terminals 111 via the local network 140 and sends that information to the monitoring center 120 through the wide area network 130. Besides, the sensing information collecting station 110 has a function that controls sending to the monitoring center 120, based on response information sent from the monitoring center 120. Alternatively, the sensing information collecting station 110 has a function that controls sending to the monitoring center 120, based on delay time information sent from the monitoring center 120 or a router 131. Besides, the sensing information collecting station 110 has a function that controls a wide area network communication function, based on notification from the router 131 or the monitoring center 120. The sensing information collecting station 110 also may have a function that changes the operation of a sensing terminal 111 through the local network 140 according to control from the monitoring center 120 through the wide area network 130.

The monitoring center 120 has the wide area network communication function and receives sensor sensing information collected at the sensing information collecting station 110 through the wide area network 130. The monitoring center 120 also may have a function that transmits response information and delay time information, based on information received through the wide area network 130. The monitoring center 120 may have any of or a plurality of the following: a storage device storing received sensor sensing information; an analysis device analyzing sensor sensing information; and a display device displaying sensor sensing information. The monitoring center 120 also may have a function that controls the operation of either or both of the sensing information collecting station 110 and a communication terminal 111.

The wide area network 130 may be a LAN in which, for example, IEEE802.11 or IEEE802.3 is used as a physical layer, or a MAN (Metropolitan Area Network) in which, for example, IEEE802.16 is used as a physical layer, or a cellular network, or a wireless or wired network comprising a combination of the mentioned ones. A router 131 performs forwarding communication data within the wide area network 130 and establishing a connection between different networks. A router 131 may transmit delay time information, based on communication data forwarded by it. A router 131 also may control communication for forwarding, based on received delay time information. The local network 140 may be a PAN (Personal Area Network) in which, for example, IEEE802.15.4 is used as a physical layer, or a LAN (Local Area Network) in which, for example, IEEE802.11 or IEEE802.3 is used as a physical layer, or a cellular network, or a wireless or wired network comprising a combination of the mentioned ones.

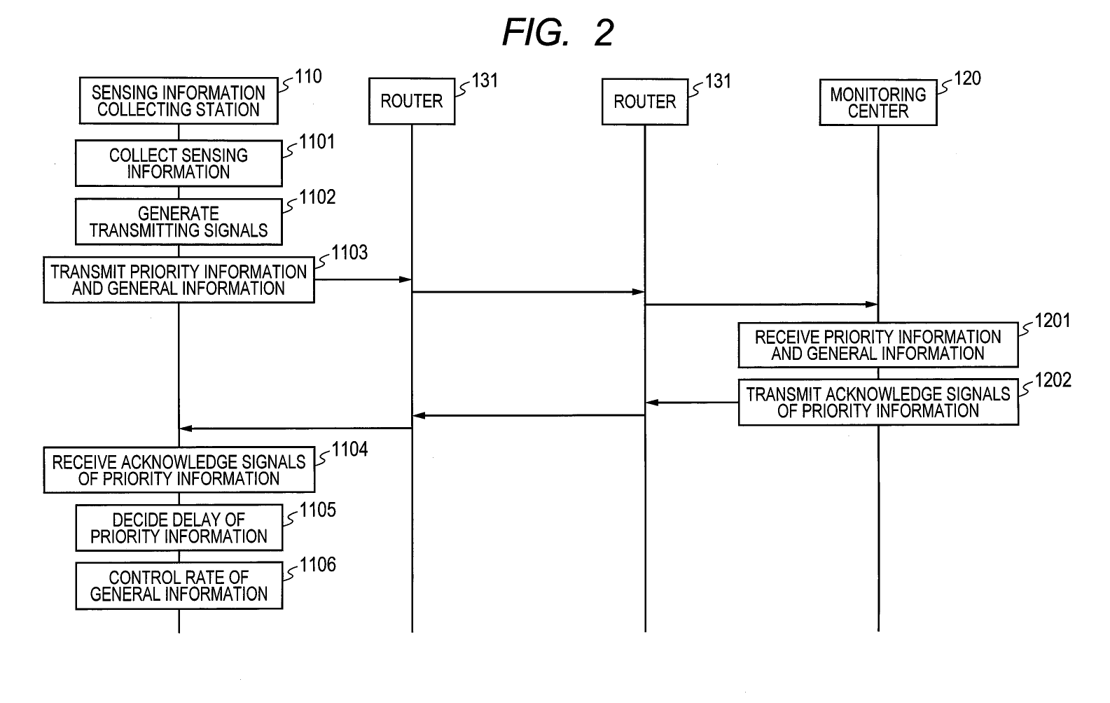

FIG. 2 shows an example of a sequence in the remote monitoring system according to the first embodiment. In FIG. 2 and subsequent examples, a case where two routers 131 exist in the wide area network 130 is exemplified; however, the number of routers 131 may be any other number. To simplify explanation, only one process flow is described in the following sequence; however, a plurality of process flows may be performed in a pipeline manner.

The sensing information collecting station 110 first acquires, collects, and stores sensor sensing information sent from one or more sensing terminals 111 in a step of collecting sensing information 1101. Then, the sensing information collecting station 110 generates transmission signal information based on the stored sensor sensing information in a step of generating a transmission signal 1102.

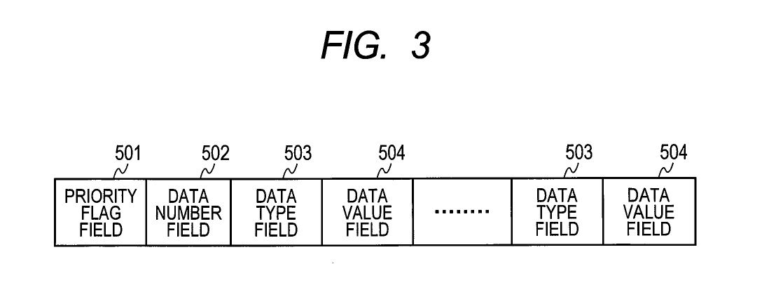

FIG. 3 shows an example of transmission signal information according to embodiments described herein. Transmission signal information includes information of a priority flag field 501, information of data number field 502 and one or more pairs of information of data type field 503 and information of data value field 504.

The priority flag field 501 contains a code that distinguishes whether the transmission signal information is priority information (first information) or general information (second information). For example, this code takes a value of 1 if the transmission signal information is priority information and a value of 0 if the transmission signal information is general information. The data number field 502 indicates the number of pairs of information of the data type field 503 and data value field 504 included in the transmission signal information. For example, when the information of the data number field 502 indicates data count=3, three pieces of information of the data type field 503 and three pieces of information of the data value field 504 are included in the transmission signal information.

The data type field 503 indicates what type of value is contained in data value field 504. This information may be a sensor type such as, e.g., a temperature sensor and a position sensor, discrimination between a measurement result measured by a single sensor and a representative value obtained from measurement results measured by a plurality sensors, an index indicating a sensor number or a combination of sensor numbers, time information indicating a time instant of sensor measurement, etc. In the data value field 504, a value as indicated by the data type field 503 is contained.

In a step of transmitting priority information and transmitting general information 1103 following the step of generating a transmission signal 1102, the sensing information collecting station 110 transmits a priority information signal and a general information signal generated by attaching a sequence number or a sequence number and transmission time instant information to the transmission signal information generated in the step of generating a transmission signal 1102, addressing these signals to the monitoring center 120 over the wide area network 130, and stores the transmission time instant and the sequence number. In the wide area network 130, the routers 131 forward the priority information signal and general information signal they received.

In a step of receiving priority information and receiving general information 1201, the monitoring center 120 receives the priority information signal and the general information signal, stores the received information into a storage device in the monitoring center 120, and outputs that information to an output device in the monitoring center 120.

Following or concurrently with the step of receiving priority information and receiving general information 1201, the monitoring center 120 transmits a priority information response signal over the wide area network 130 in a step of transmitting a priority information response signal 1202. The priority information response signal is information indicating successful reception of priority information by the monitoring center 120 or unsuccessful reception of priority information by the monitoring center 120 and includes the sequence number of the corresponding priority information. In the wide area network 130, the routers 131 forward the priority information response signal they received.

The sensing information collecting station 110 receives the priority information response signal through the wide area network 130 in a step of receiving a priority information response signal 1104. Then, the sensing information collecting station 110 determines a delay time from a difference between the reception time instant of the received priority information response signal and the transmission time instant of the corresponding priority information in a step of determining a priority information delay time 1105. In a step of rate control of general information 1105, the sensing information collecting station 110 then determines a transmission rate of a general information signal which should be generated in the step of generating a transmission signal 1102 and transmitted in the step of transmitting priority information and general information 1103. Here, the transmission rate of a general information signal is selected so that the transmission rate should become smaller when the delay time is larger or the transmission rate should become larger when the delay time is smaller or the transmission rate is negatively correlated with the delay time.

By repeating the process as described above, the remote monitoring system according to the first embodiment estimates a fluctuation in the network using a priority information signal and controls the rate of a general information signal; thereby, it is possible for the system to stably communicate priority information that requires a low delay, while communicating other general sensing information in adapting to a fluctuation in the network quality.

The sensing information collecting station 110 and the monitoring center 120 may communicate with each other via at least one router 131 that implements priority control located within the wide area network 130 and priority information and general information which are transmitted from the sensing information collecting station 110, for example, may be handled as those of a same priority class by the router 131. According to this configuration, it is possible to prevent priority information from delaying, keeping priority setting in the wide area network as is. In particular, whereas priority setting in the wide area network is set up by a network operator, setup can be performed by a user who uses an entity in the remote monitoring system, such as the network communication apparatus and the monitoring apparatus.

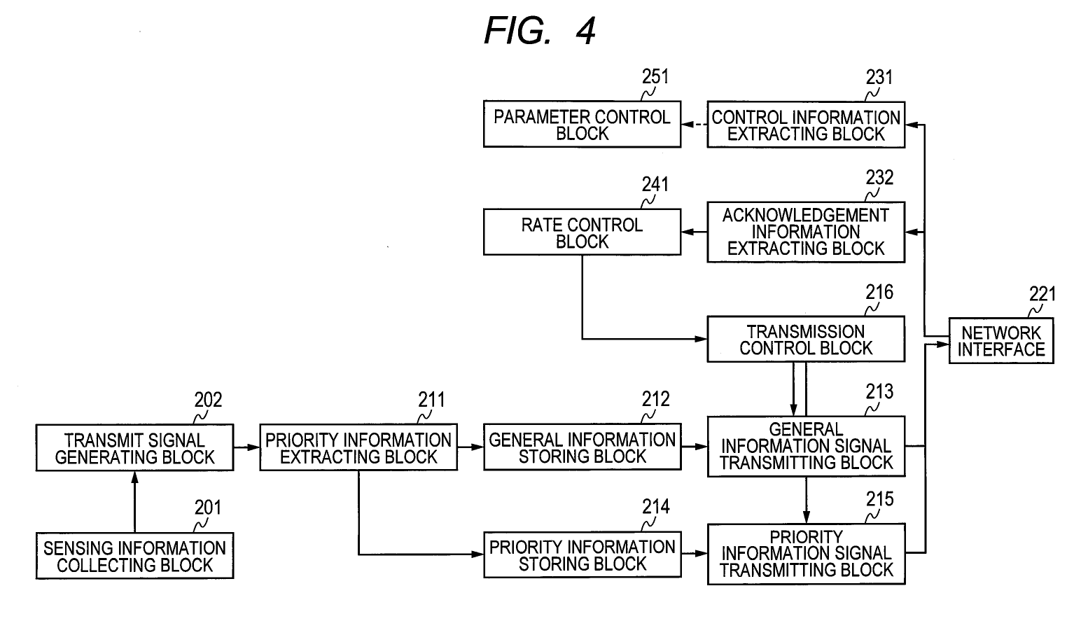

FIG. 4 shows an example of a functional block diagram depicting a structure of the sensing information collecting station 110 in the remote monitoring system of the first embodiment.

The sensing information collecting station 110 according to the present invention includes a sensing information collecting block 201, a transmit signal generating block 202, a priority information extracting block (sorting unit) 211, a general information storing block 212, a general information signal transmitting block (non-priority information transmitting unit) 213, a priority information storing block 214, a priority information signal transmitting block 215, a transmission control block 216, a network interface 221, a control information extracting block 231, a acknowledgement information extracting block (delay time obtaining unit) 232, a rate control block 241, and a parameter control block 251. Each of these units can be implemented by CPU/DSP modules and memories, as will be described later.

The parameter control block 251 retains parameters relating to the operation of each unit in the sensing information collecting station 110 and sets and changes operating parameters for each unit. Here, the operating parameters are, for example, priority transmission conditions and general transmission conditions for the transmit signal generating block 202. In another example, the operating parameters are, for example, a priority information transmission interval Tp, a priority information transmission rate Rp, a maximum transmission rate of general information Rgmax, and a minimum transmission rate of general information Rgmin for the transmission control block 216 and the rate control block 241.

The parameter control block 251 also updates a parameter it retains, based on control information input from the control information extracting block 231. The parameter control block 251 also sends a parameter relating to a measurement to a sensing terminal 111 through the local network 140. Here, the parameter relating to a measurement is, for example, a sensor type that is used for a measurement at a sensing terminal 111; or, for example, a frequency of measurement that is performed at a sensing terminal 111; or, for example, a frequency at which a sensing terminal 111 reports sensing information to the sensing information collecting station 110; or, for example, a communication parameter such as a channel for a communication terminal 111 to perform communication through the local network 140 among others.

The sensing information collecting block 201 performs the step of collecting sensing information; i.e., it acquires, collects, and stores sensor sensing information sent from one or more sensing terminals 111.

The transmit signal generating block 202 performs the step of generating a transmission signal; i.e., it generates a transmission signal as shown in FIG. 3, based on sensor sensing information stored by the sensing information collecting block 201 and priority transmission conditions and general transmission conditions that are set by the parameter control block 251. The priority transmission conditions cause the transmit signal generating block 202 to output a transmission signal in which a code indicating that it is priority information is given to the priority flag field 501. The priority transmission conditions may include, for example, a sensor type, a sensor number (or identifier) or a combination of sensor numbers (identifiers), information as to what is a value to be transmitted, which may be a measurement value itself or statistical information such as an average and a standard deviation, or which may be a maximum value, a minimum value, or a rank value such as a 95% value for a predetermined period of time or measurement values measured by a plurality of sensors, and a range condition that is satisfied only if these values are equal to or more than a certain level. As the priority transmission conditions, for example, if the following conditions are specified: a temperature sensor as a sensor type, No. 1 to No. 5 as sensor numbers, and an average as a value, the transmit signal generating block 202 outputs a transmission signal including a code indicating priority information given to the priority flag field 501 and an average of sensing information measured by temperature sensors No. 1 to No. 5. The general transmission conditions cause the transmit signal generating block to output a transmission signal in which a code indicating that it is non-priority information (or general information) is given to the priority flag field 501 and they are similar to the priority transmission conditions except that a code indicating non-priority information is given to the priority flag field 501. Either priority transmission conditions or general transmission conditions may be specified and conditions other than the priority flag field may also apply to the other.

For example, a condition can be set to transmit sensing information from all sensing terminals as a general transmission condition and to transmit sensing information only if a value of sensing information becomes equal to or more than a certain level as a priority transmission condition. In this case, for sensing information requiring special handling, the monitoring center 120 receives it at a low delay as priority information and receives other sensing information separately as general information. This can be useful for, inter alia, quickly detecting a specific abnormal value. Besides, for example, a condition can be set to transmit sensing information from an individual sensing terminal as a general transmission condition and to transmit statistical information such as an average of sensing information from a plurality of sensing terminals as a priority transmission condition. In this case, for information representing a global tendency, the monitoring center 120 receives it at a low delay as priority information and receives individual sensing information separately as general information. This can be useful for, inter alia, quickly detecting an abnormality in a global tendency.

The priority information extracting block 211 extracts priority information out of transmission signal information which has been input from the transmit signal generating block 202 according to the priority flag field 501 and outputs it to the priority information storing block 214. The priority information extracting block 211 also outputs non-priority information out of transmission signal information which has been output from the transmit signal generating block 202 according to the priority flag field 501 to the general information storing block 212. The general information storing block 212 stores transmission signal information which has been input from the priority information extracting block 211. The general information storing block 212 also outputs transmission signal information stored therein to the general information signal transmitting block 213 in response to an instruction from the general information signal transmitting block 213.

The general information signal transmitting block 213 performs the step of transmitting general information; i.e., it adds a sequence number and time instant information representing the current time to a transmission signal retrieved from the general information storing block 212 and outputs the transmission signal to the network interface 221, according to a transmission control signal sent from the transmission control block 216.

The priority information storing block 214 stores transmission signal information which has been input from the priority information extracting block 211. The priority information storing block 214 also outputs transmission signal information stored therein to the priority information signal transmitting block 215 in response to an instruction from the priority information signal transmitting block 215.

The priority information signal transmitting block 215 performs the step of transmitting priority information; i.e., it adds a sequence number and time instant information representing the current time to a transmission signal retrieved from the priority information storing block 214 and outputs the transmission signal to the network interface 221, according to a transmission control signal sent from the transmission control block 216.

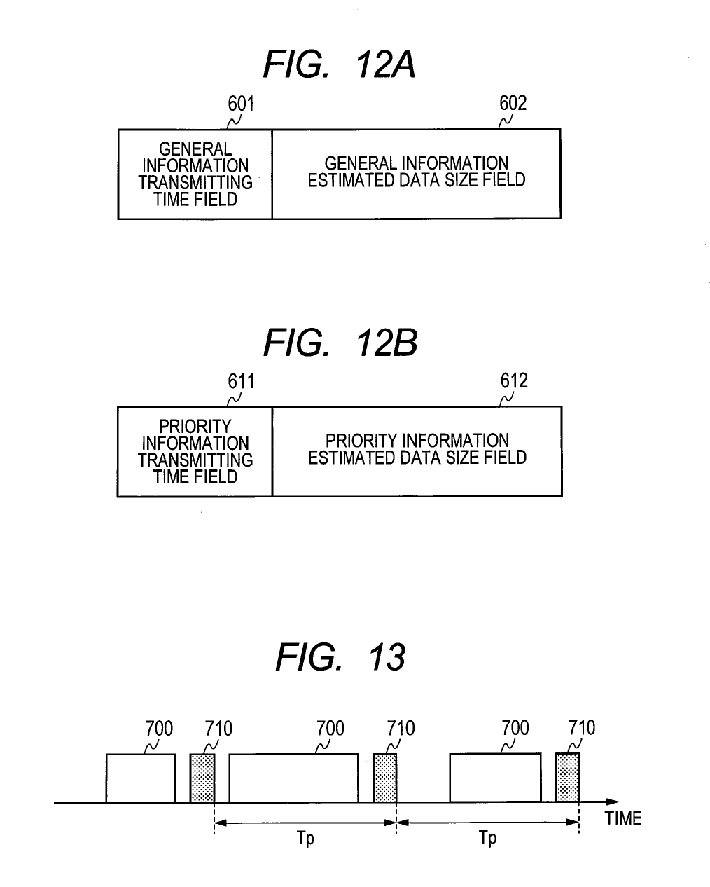

The transmission control block 216 sends transmission control signals to the general information signal transmitting block 213 and the priority information signal transmitting block 215, based on a general information transmission rate Rg and operating parameters sent from the rate control block 241. FIGS. 12A and 12B show examples of transmission control signals which are sent from the transmission control block 216 to the general information signal transmitting block 213 and the priority information signal transmitting block 215. A transmission control signal (FIG. 12A) which is sent from the transmission control block 216 to the general information signal transmitting block 213 includes a time instant to transmit general information in the general information transmitting time field 601 and a general information estimated data size field 602. The general information signal transmitting block 213 outputs an amount of data specified by the general information estimated data size field 602 to the network interface 221 at a time instant specified by the general information transmitting time field 601. A transmission control signal (FIG. 12B) which is sent from the transmission control block 216 to the priority information signal transmitting block 215 includes a priority information transmitting time field 611 and a priority information estimated data size field 612. The priority information signal transmitting block 215 outputs an amount of data specified by the priority information estimated data size field 612 to the network interface 221 at a time instant specified by the priority information transmitting time field 611. If an amount of data that can be transmitted by the general information signal transmitting block 213 and the priority information signal transmitting block 215 is less than the specified data amount to be transmitted, only the amount of data that can be transmitted may be output to the network interface 221 or padding may be appended to offset a shortage of data amount. A data amount that should be output by the priority information signal transmitting block 215 to the network interface 221 may be fixed and preset as a parameter. Accordingly, the priority information estimated data size field 612 may not be included in a transmission control signal which is sent from the transmission control block 216 to the priority information signal transmitting block 215. An actual value representing a time instant may not be contained in the general information transmitting time field 601 and the priority information transmitting time field 611. Instead, the general information signal transmitting block 213 and the priority information signal transmitting block 215 may recognize, for example, a time instant of reception of a transmission control signal from the transmission control block 216 or a time upon the elapse of a given period after the signal reception as the time instant to transmit.

Operating parameters that are received by the transmission control block 216 from the parameter control block 251 include, for example, a priority information transmission rate Rp and a priority information transmission interval Tp. Each of these pieces of information, for example, can be included in control information from the monitoring center 120. In this case, the priority information transmitting time field 611 that the transmission control block 216 sends to the priority information signal transmitting block 215 is equal to the sum of the time instant to transmit that it sent the last time and the priority information transmission interval Tp received as a parameter. The priority information estimated data size field 612 is selected to be equal to the product of the priority information transmission interval Tp and the priority information transmission rate Rp. The time instant to transmit general information in the general information transmitting time field 601 that the transmission control block 216 sends to the general information signal transmitting block 213 is equal to the sum of the time instant to transmit that it sent the last time and the priority information transmission interval Tp received as a parameter. The general information estimated data size field 602 is selected to be equal to the product of the priority information transmission interval Tp and the general information transmission rate Rg.

FIG. 13 is a schematic diagram representing an order of information signals which are input from the general information signal transmitting block 213 and the priority information signal transmitting block 215 to the network interface 221. For example, every priority information signal 710 having an equal data amount is input to the network interface 221 periodically in each priority information transmission interval Tp, whereas every general information signal 700 having a data amount specified by the transmission control block 216, interposed between two priority information signals 710, is input to the network interface 221.

The network interface 221 transmits transmission signals which have been input from the general information signal transmitting block 213 and the priority information signal transmitting block 215 onto the wide area network 130. The network interface 221 also outputs signals received through the wide area network 130 to the control information extracting block 231 and the acknowledgement information extracting block 232.

The control information extracting block 231 extracts control information transmitted by the monitoring center 120 from a signal received by the network interface 221 and outputs it to the parameter control block 251.

The acknowledgement information extracting block 232 extracts response information transmitted by the monitoring center 120 from a signal received by the network interface 221 and derives a sequence number from the response information. The acknowledgement information extracting block 232 also performs the step of determining a priority information delay time; i.e., it determines a delay time from a difference between the reception time instant of the response information and the transmission time instant of the transmission signal corresponding to the derived sequence number and sends the delay time obtained as the result to the rate control block 241. The rate control block 241 estimates the network condition, based on the delay time sent to it, and determines a general information transmission rate Rg and then sends the general information transmission rate Rg to the transmission control block 216.

FIG. 15 is an outline diagram of a hardware structure of a component apparatus, configured mainly with DSP and CPU, of the present remote monitoring system.

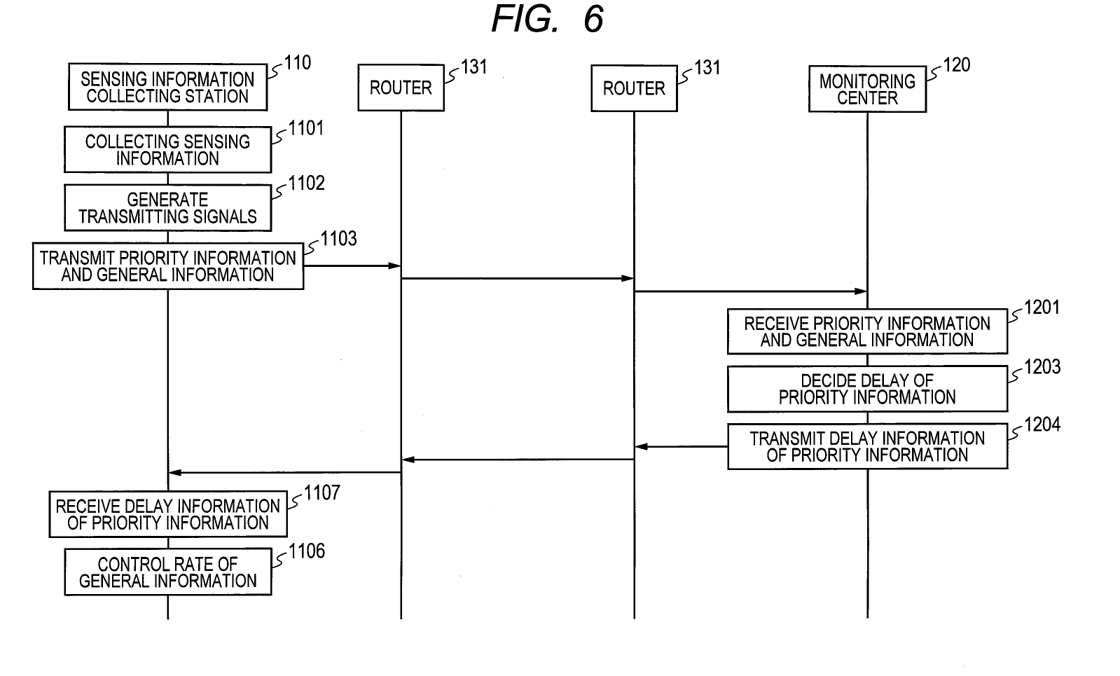

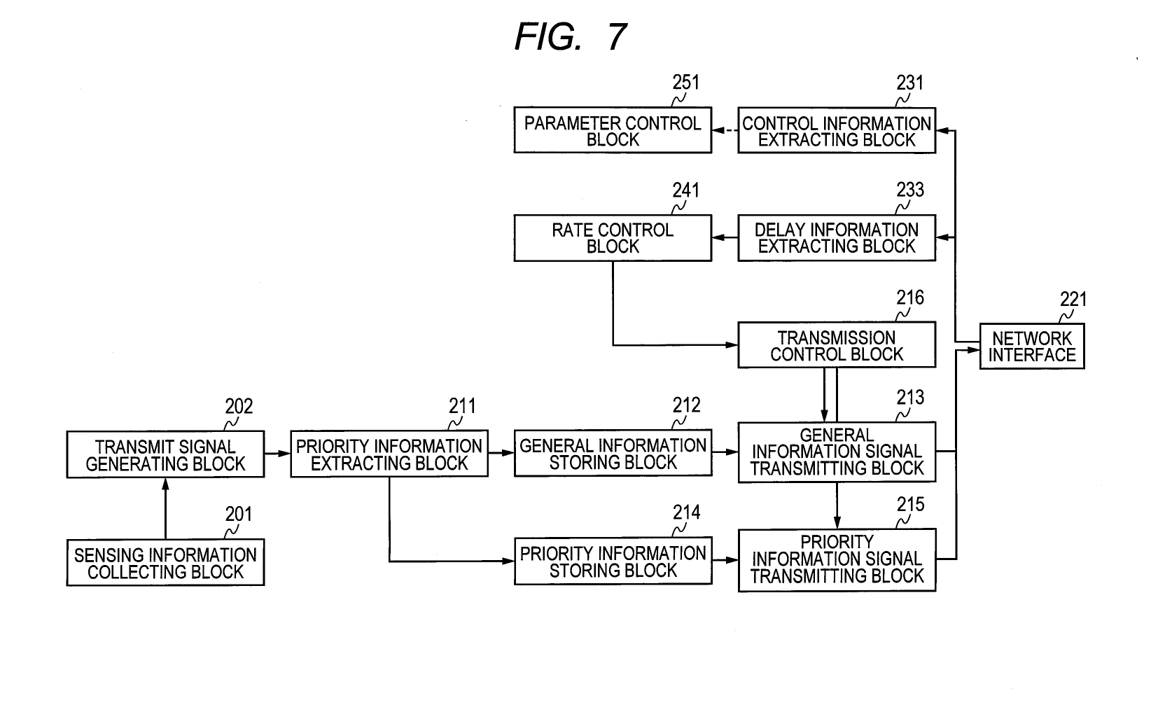

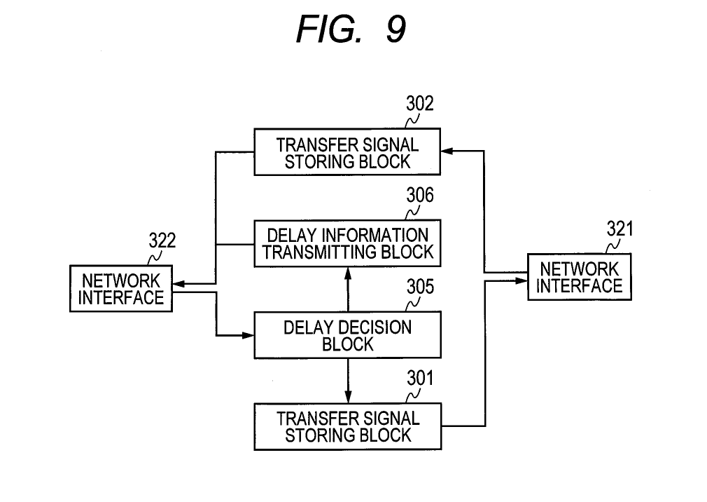

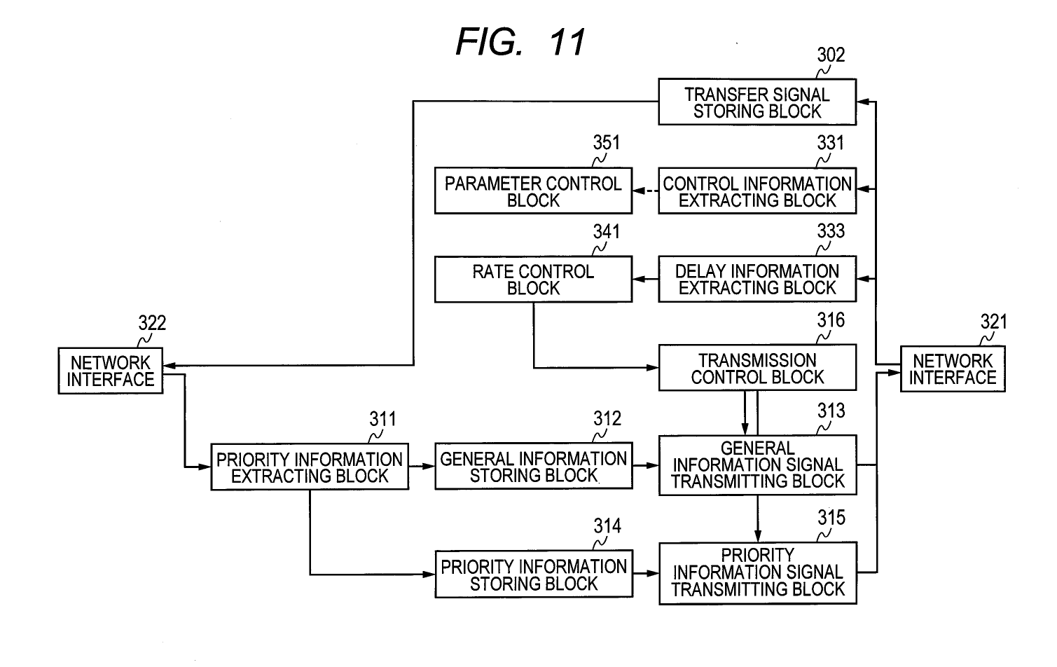

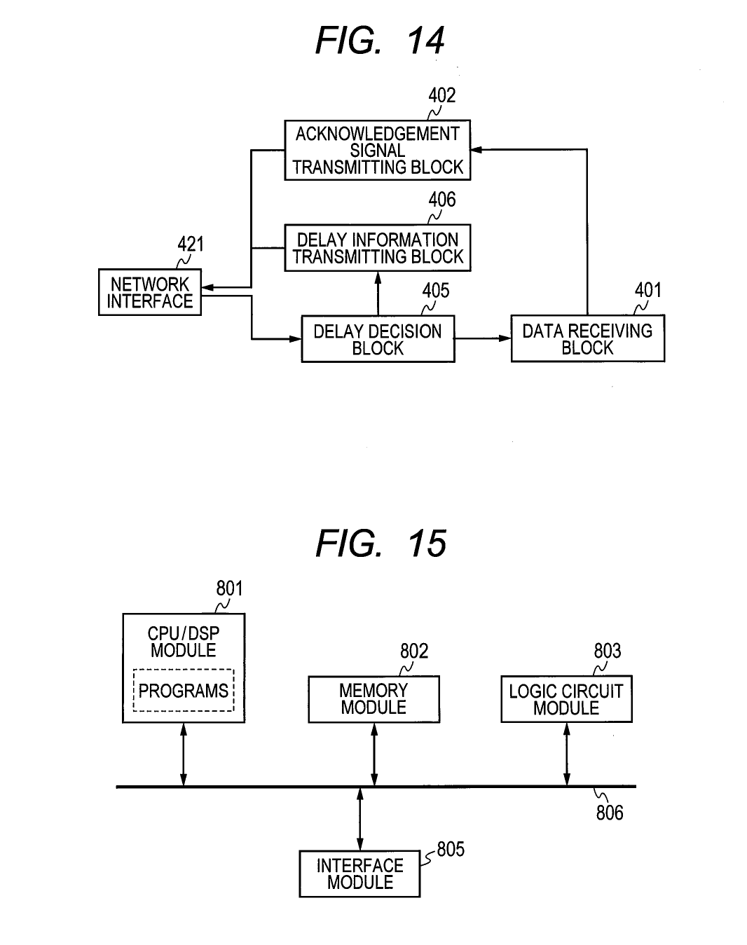

Component apparatuses of the present remote monitoring system are, for example, the sensing information collecting station 110, routers 131, and monitoring center 120. More specifically, the component apparatuses are the sensing information collecting station of the present embodiment shown in the functional block diagram of FIG. 4 and, according to respective embodiments which will be described later, a sensing information collecting station which is shown in a functional block diagram of FIG. 7, routers which are shown in functional block diagrams of FIGS. 9 and 11, and a monitoring center which is shown in a functional block diagram of FIG. 14. The component apparatus shown in FIG. 15 includes a CPU/DSP module 801, a memory module 802, a logical circuit module 803, and an interface module 805, each of which is interconnected via a bus 806.

Processing that is performed by each functional unit (e.g., each unit shown in FIG. 4) in the respective functional block diagrams of each apparatus is performed by using either or both of a program in the CPU/DSP module 801 and an operational circuit in the logic circuit module 803 and the memory module 802 if necessary. Information required by each module in the respective functional blocks, for example, operating parameters which are stored in the parameter control block 251 (or a parameter control block 351 which will be described later) and sensing information which is stored in the sensing information collecting block 201, among others, are retained in the memory module 802. For a router 131, inter alia, signals to be forwarded are retained in the memory module 802.

The interface module 805 establishes a connection on a physical layer of wireless communication and wired communication with the network interface 221 (or network interfaces 321, 322, 421 which will be described later) in the respective functional blocks.

Note that each module and the bus shown in FIG. 15 are not necessarily single ones. There may be, for example, a plurality of CPU/DSP modules 801 and a plurality of buses 806. In a case where there are a plurality of buses 806, all buses are not necessarily connected to all modules; for example, a bus for only connecting the memory module 802 and the logic circuit module 803 may exist besides a bus connected to all modules.

If, for example, signal processing operation and signal processing control in all functions can be performed by the CPU/DSP module(s) 801, the logic circuit module 803 may be dispensed with. Conversely, if signal processing operation and signal processing control in all functions can be performed by the logical operation module (s) 803, the CPU/DSP module 801 may be dispensed with.

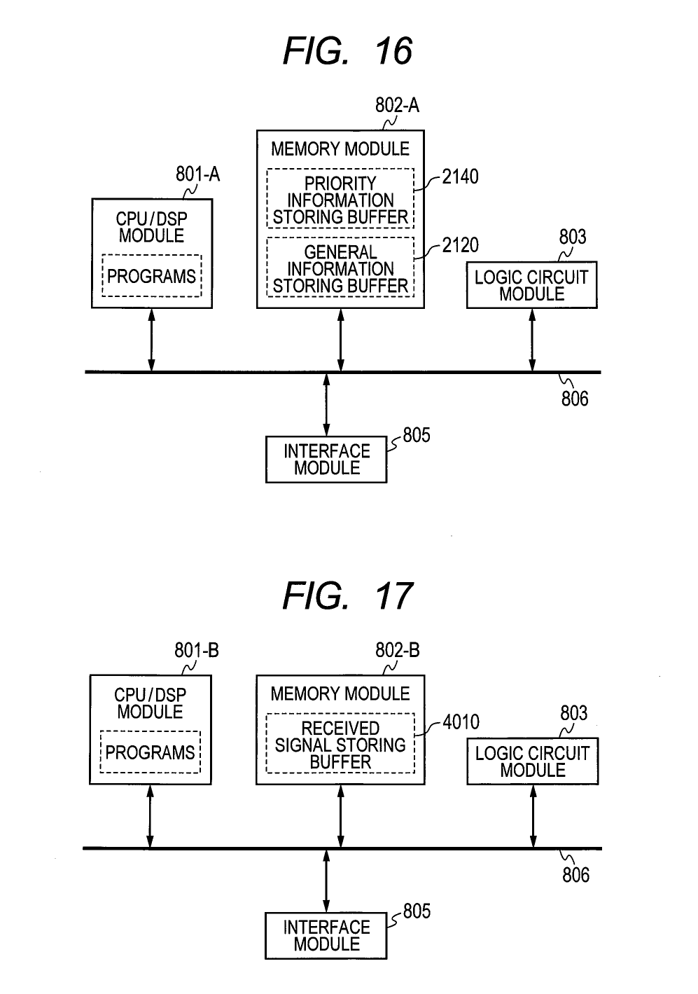

FIG. 16 is a diagram showing an example of a hardware structure of the sensing information collecting station 110.

The memory module 802-A of the sensing information collecting station 110 includes a priority information storing buffer 2140 and a general information storing buffer 2120. These buffers correspond to the priority information storing unit 214 and the general information storing unit 212 shown in FIG. 4, respectively. The memory module 802-A may additionally include a sensing information buffer for storing received sensing information. Parameters to be set, inter alia, are stored in the memory module 802-A.

The CPU/DSP module 801-A of the sensing information collecting station 110 executes a predefined program and implements each functional unit shown in FIG. 4. Programs are stored in the memory module 802-A and can be read as appropriate. Other details of the structure are the same as in FIG. 15.

FIG. 5 is a graph showing an example of a relationship between a delay time which has been sent and a general information transmission rate Rg which is determined. When the delay time is larger, it is estimated that the network is in a congested state. Thus, the general information transmission rate Rg is determined so that it should become smaller when the delay time is larger and should tend to increase, as the delay time becomes smaller, in the relationship of FIG. 5. For example, a function may be predetermined. Alternatively, the entire range of delay time may be divided into certain time segments and reference may be made to a table in which general information transmission rates associated with the time segments are stored. However, Rg values can be restricted to a range between a maximum transmission rate of general information Rgmax at a maximum and a minimum transmission rate of general information Rgmin at a minimum. When obtaining a general information transmission rate Rg from a delay time, a delay time that has just been sent may be used directly or an average delay time may be used after averaging delay times together with past delay time information. A general information transmission rate Rg obtained according to the relationship as in FIG. 5 may be sent, as is, to the transmission control block 216 or an average of such rates obtained by averaging rates together with past general information transmission rates Rg may be sent to the transmission control block 216 to avoid a steep change.

Generally, a data communication rate that is assigned to each data communication changes, as the state of congestion in a network changes and, as the communication environment changes particularly in the case of radio communication. When data communication is performed, a communication delay occurs which corresponds to a value obtained by dividing the data amount by the data communication rate assigned to the data communication. Therefore, by using the relationship between delay time and general information transmission rate Rg as in FIG. 5, the general information transmission rate Rg is controlled to decrease when the delay time increases due to network congestion or the like. As a result, the aggregate amount of data that is transmitted over the network decreases and, thus, the delay time decreases. Conversely, the general information transmission rate Rg is controlled to increase when the delay time decreases due to clearance of network congestion or the like and, consequently the delay time increases.

### 2. Second Embodiment

In the foregoing first embodiment, an example of the case where the sensing information collecting station 110 determines a network delay time based on a response signal to priority information that the sensing information collecting station 110 transmitted to the monitoring center 120 and the sensing information collecting station 110 performs general information rate control has been described. On the other hand, it is also possible that, without the use of a response signal in determining a network delay time, the monitoring center 120 determines a network delay time and sends it to the sensing information collecting station 110 and the sensing information collecting station 110 performs general information rate control.

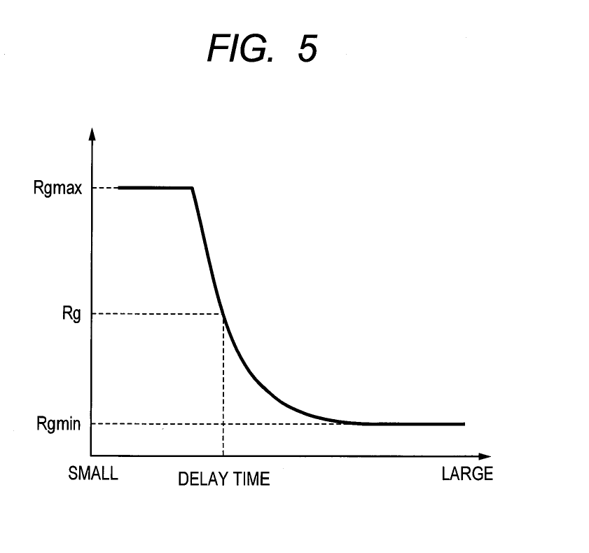

FIG. 6 shows an example of a sequence in the remote monitoring system according to a second embodiment. The sensing information collecting station 110 first acquires, collects, and stores sensor sensing information sent from one or more sensing terminals 111 in a step of collecting sensing information 1101. Then, the sensing information collecting station 110 generates transmission signal information based on the stored sensor sensing information in a step of generating a transmission signal 1102. Here, the transmission signal information is the same as the transmission signal information in the first embodiment.

In a step of transmitting priority information and transmitting general information 1103 following the step of generating a transmission signal 1102, the sensing information collecting station 110 then transmits a priority information signal and a general information signal generated by attaching a transmission time instant and a sequence number to the transmission signal information generated in the step of generating a transmission signal 1102, addressing these signals to the monitoring center 120 over the wide area network 130, and stores the transmission time instant and the sequence number. In the wide area network 130, the routers 131 forward the priority information signal and general information signal they received.

In a step of receiving priority information and receiving general information 1201, the monitoring center 120 receives the priority information signal and the general information signal, stores the received information into a storage device in the monitoring center 120, and outputs that information to an output device in the monitoring center 120.

In a step of determining a priority information delay time 1203, the monitoring center 120 also determines a delay time of the priority information from a difference between a time instant when the priority information has been received by the monitoring center 120 and time instant information attached to the priority information when transmitted in the step of transmitting priority information and general information 1103. The sensing information collecting station 110 and the monitoring center 120 can be synchronized in time by an appropriate method. In a step of transmitting a priority information delay time 1204, the monitoring center 120 then transmits a priority information delay time signal including the delay time of the priority information determined in the step of determining a priority information delay time and the sequence number of the priority information, addressing this signal to the sensing information collecting station 100 over the wide area network 130. In the wide area network 130, the routers 131 forward the priority information delay time signal they received.

The sensing information collecting station 110 receives the priority information delay time signal through the wide area network 130 in a step of receiving a priority information delay time signal 1107. In a step of rate control of general information 1106, based on the received delay time, the sensing information collecting station 110 then determines a transmission rate of a general information signal which should be generated in the step of generating a transmission signal 1102 and transmitted in the step of transmitting priority information and general information 1103. Here, the transmission rate of a general information signal is selected so that the transmission rate should become smaller when the delay time is larger or the transmission rate should become larger when the delay time is smaller or the transmission rate is negatively correlated with the delay time, as is the case for the first embodiment.

By repeating the process as described above, the remote monitoring system according to the second embodiment estimates a fluctuation in the network using a priority information signal and controls the rate of a general information signal; thereby, it is possible for the system to stably communicate priority information that requires a low delay, while communicating other general sensing information in adapting to a fluctuation in the network quality.

FIG. 7 shows an example of a functional block diagram of the sensing information collecting station 110 of the second embodiment. Here is included a delay information extracting block (delay time obtaining unit) 233 instead of the acknowledgement information extracting block 232 in the sensing information collecting station shown in FIG. 4, but otherwise are the same.

More specifically, the sensing information collecting station 110 according to the present embodiment includes a sensing information collecting block 201, transmit signal generating block 202, priority information extracting block 211, general information storing block 212, general information signal transmitting block 213, priority information storing block 214, priority information signal transmitting block 215, transmission control block 216, network interface 221, control information extracting block 231, delay information extracting block 233, rate control block 241, and parameter control block 251. In the sensing information collecting station 110 according to the present embodiment, the sensing information collecting block 201, transmit signal generating block 202, priority information extracting block 211, general information storing block 212, general information signal transmitting block 213, priority information storing block 214, priority information signal transmitting block 215, transmission control block 216, network interface 221, control information extracting block 231, rate control block 241, and parameter control block 251 each operate in the same way as those with corresponding names in the foregoing first embodiment.

The delay information extracting block 233 performs the step of receiving a priority information delay time; i.e., it extracts delay time information from a signal received by the network interface 221 and sends the extracted delay time to the rate control block 241.

The hardware structure of the sensing information collecting station 110 is the same as for the first embodiment. For example, the CPU/DSP module 801-A executes a program and implements each functional unit shown in FIG. 7.

FIG. 14 shows an example of a functional block diagram of the monitoring center 120 of the second embodiment.

The monitoring center of the second embodiment includes a network interface 421, a data receiving block 401, an acknowledgement signal transmitting block 402, a delay decision block 405, and a delay information transmitting block 406.

The network interface 421 receives a signal transmitted from the sensing information collecting station 110 via the network 130 and outputs it to the delay decision block 405. The network interface 421 also transmits a signal which has been input from the acknowledgement signal transmitting block 402 and the delay information transmitting block 406 to the sensing information collecting station 110 via the network 130.

The delay decision block 405 outputs a signal which has been input from the network interface 421, as is, to the data receiving block 401. The delay decision block 405 also checks the priority flag field 501 of a signal which has been input from the network interface 421 and, if the priority flag field 501 contains a code representing priority information, calculates a difference between the time instant information attached to the signal when transmitted and the current time instant as a delay time, and then sends the sequence number attached to the signal when transmitted and the delay time to the delay information transmitting block 406.

The delay information transmitting block 406 outputs the sequence number and delay time sent to it to the network interface 421 as delay time information.

The data receiving block 401 receives priority information and general information transmitted from the sensing information collecting station 110 and performs storing, analyzing, and displaying received data, among others. Each time receiving a data signal properly, the data receiving block 401 sends the sequence number attached to the signal when transmitted to the acknowledgement signal transmitting block 402.

The acknowledgement signal transmitting block 402 generates a response signal indicating that the signal corresponding to the sequence number has been received properly and outputs it to the network interface 421.

FIG. 17 is a diagram showing an example of a hardware structure of the monitoring center 120.

The memory module 802-B of the monitoring center 120 includes a received signal storing buffer 4010.

The CPU/DSP module 801-B of the monitoring center 120 executes a predetermined program and implements each functional unit shown in FIG. 14. Programs are stored in the memory module 802-B and can be read as appropriate. Other details of the structure are the same as in FIG. 15.

### 3. Third Embodiment

In the foregoing second embodiment, an example where the monitoring center 120 determines a network delay time and the sensing information collecting station 110 performs rate control of general information. This is an example of determining a delay time for the entire network from the sensing information collecting station 110 to the monitoring center 120 as the network delay time. On the other hand, in a case where a network delay time fluctuates prominently in a partial section of the network, it is also possible to determine a network delay time after priority information and general information has passed the section and perform rate control of general information before priority information and general information pass the section. For example, any apparatus may determine a network delay time and another apparatus may perform rate control of general information; this manner of implementation can also produce the same effect.

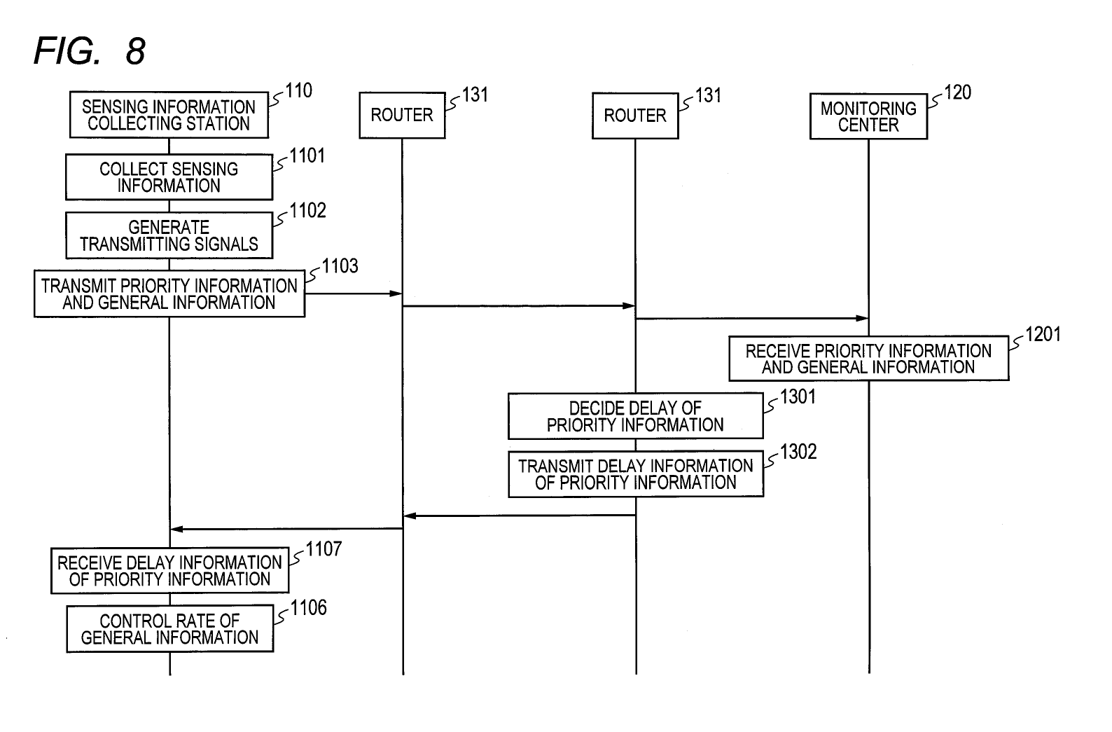

FIG. 8 shows an example of a sequence in the remote monitoring system according to the third embodiment.

In the sequence in the remote monitoring system according to the third embodiment, as compared with the second embodiment, the step of determining a priority information delay time 1203 and the step of transmitting a priority information delay time 1204 at the monitoring center 120 are removed and a step of determining a priority information delay time 1301 and a step of transmitting a priority information delay time 1302 at a router 131 are added. Other steps are the same as in the sequence in the remote monitoring system according to the second embodiment shown in FIG. 6.

The router 131 that performs the step of determining a priority information delay time 1301 and the step of transmitting a priority information delay time 1302 may be any router 131 in the wide area network 130. However, as an example, this role can be served by a router at the egress of a section in which a network delay time fluctuates prominently. For example, a router at which communication data from the sensing information collecting station 110 arrives after having passed a radio network section can be appropriate for this task.

In the step of determining a priority information delay time 1301, the router 131 determines a delay time of priority information from a difference between a time instant when it has received priority information to be forwarded by the router 131 and time instant information attached to the priority information when transmitted in the step of transmitting priority information and general information 1103. In the step of transmitting a priority information delay time 1302, the router 131 then transmits a priority information delay time signal including the delay time of the priority information determined in the step of determining a priority information delay time 1301 and the sequence number of the priority information, addressing this signal to the sensing information collecting station 100 over the wide area network 130. In the wide area network 130, some other router 131 forwards the priority information delay time signal it received.

By repeating the process as described above, the remote monitoring system according to the third embodiment estimates a fluctuation in the network using a priority information signal and controls the rate of a general information signal; thereby, it is possible for the system to stably communicate priority information that requires a low delay, while communicating other general sensing information in adapting to a fluctuation in the network quality.

FIG. 9 shows an example of a functional block diagram of a router 131 of the third embodiment. The router of the third embodiment includes network interfaces 312 and 322, transfer signal storing blocks 301 and 302, a delay decision block 305, and a delay information transmitting block 306.

One network interface 321 receives a signal transmitted from the monitoring center 120 toward the sensing information collecting station 110 over the network 130 and outputs it to a transfer signal storing block 302. The network interface 321 also transmits a signal which has been input from a transfer signal storing block 301 toward the monitoring center 120 over the network 130.

Another network interface 322 receives a signal transmitted from the sensing information collecting station 110 toward the monitoring center 120 over the network 130 and outputs it to the delay decision block 305. The network interface 322 also transmits a signal which has been input from the transfer signal storing block 302 and the delay information transmitting block 306 toward the sensing information collecting station 110 over the network 130.

The transfer signal storing block 301 once stores a signal which has been input from the delay decision block 305 and outputs it to the network interface 321. The transfer signal storing block 302 once stores a signal which has been input from the network interface 321 and outputs it to the network interface 322.

The delay decision block 305 outputs a signal which has been input from the network interface 322, as is, to the transfer signal storing block 301. The delay decision block 305 also checks the priority flag field 501 of a signal which has been input from the network interface 322 and, if the priority flag field 501 contains a code representing priority information, calculates a difference between the time instant information attached to the signal when transmitted and the current time instant as a delay time, and then sends the sequence number attached to the signal when transmitted and the delay time to the delay information transmitting block 306.

The delay information transmitting block 306 outputs the sequence number and delay time sent to it to the network interface 322 as delay time information.

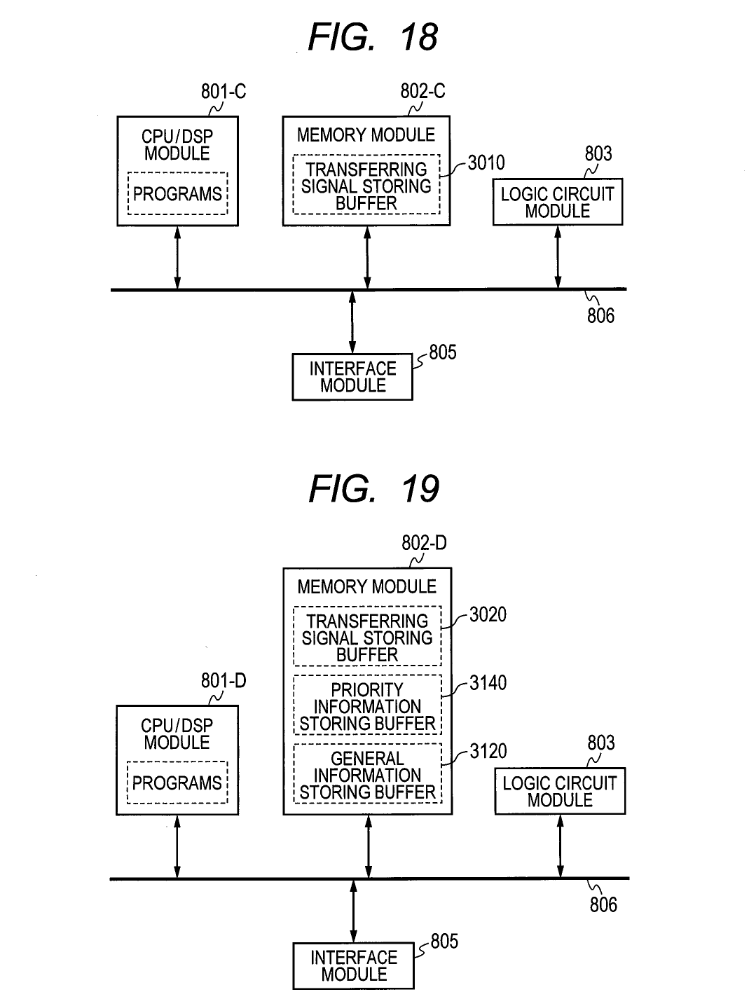

FIG. 18 is a diagram showing an example of a hardware structure of the router 131.

The memory module 802-C of the router 131 includes a transferring signal storing buffer 3010. The transferring signal storing buffer 3010 corresponds to, for example, the transfer signal storing blocks 301, 302 shown in FIG. 9.

The CPU/DSP module 801-C of the router 131 executes a predefined program and implements each functional unit shown in FIG. 9. Programs are stored in the memory module 802-C and can be read as appropriate. Other details of the structure are the same as in FIG. 15.

The structure of the sensing information collecting station 110 is the same as for the second embodiment.

### 4. Fourth Embodiment

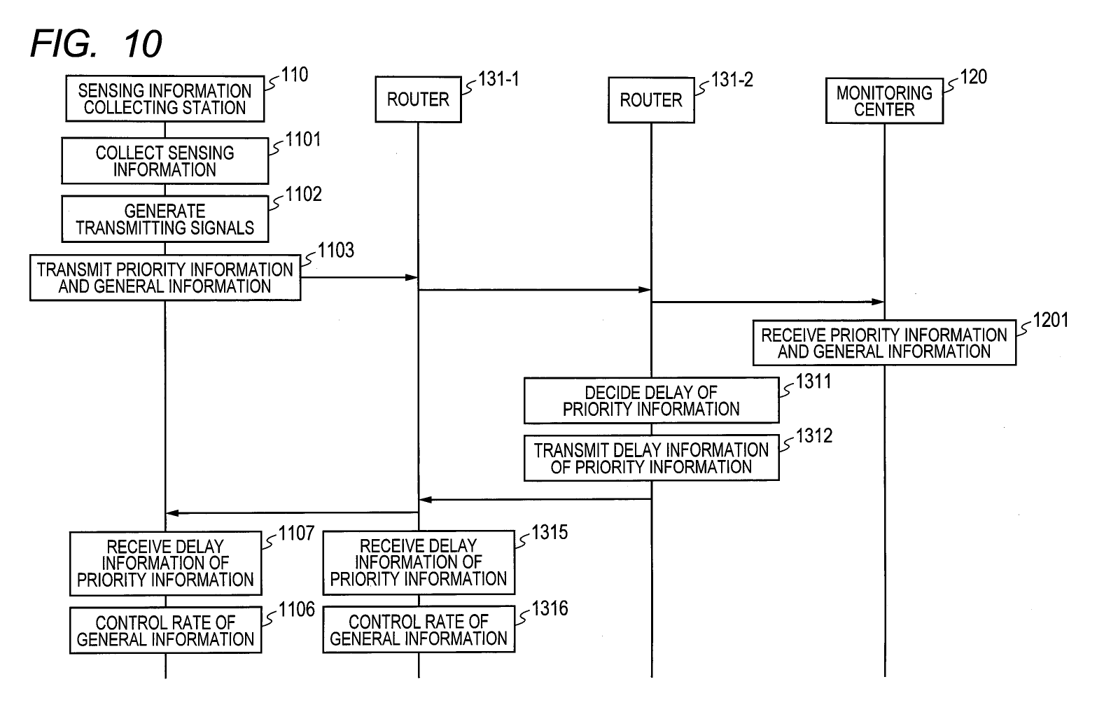

FIG. 10 shows an example of a sequence in the remote monitoring system according to a fourth embodiment. In the sequence in the remote monitoring system according to the fourth embodiment, a step of receiving a priority information delay time 1315 and a step of rate control of general information 1316 at a router 131-1 are added; otherwise are the same as the sequence in the remote monitoring system according to the third embodiment shown in FIG. 8.

The router 131-1 receives a priority information delay time signal from another router 131-2 through the wide area network 130 in the step of receiving a priority information delay time signal 1315. The router 131-1 then determines a transmission rate of a general information signal to be forwarded in the step of rate control of general information 1316. Here, the transmission rate of a general information signal is selected so that the transmission rate should become smaller when the delay time is larger or the transmission rate should become larger when the delay time is smaller or the transmission rate is negatively correlated with the delay time in the same manner as described previously. Steps 1311, 1312 are the same as the steps 1301, 1302 shown in FIG. 8.

By repeating the process as described above, the remote monitoring system according to the fourth embodiment estimates a fluctuation in the network using a priority information signal and controls the rate of a general information signal; thereby, it is possible for the system to stably communicate priority information that requires a low delay, while communicating other general sensing information in adapting to a fluctuation in the network quality.

The steps 1107 and 1016 at the sensing information collecting station 110 and the steps 1315 and 1316 at the router 131-1 may be performed by both apparatuses; however, the steps 1315 and 1316 may only be performed by the router 131-1 in the present embodiment. Determining a delay time is performed by the router 131-2, as described above; besides, the monitoring center 120 may determine a delay time as in the second embodiment. In this way, for example, it is also possible to determine a delay time at both the ingress and the egress of a section in which a network delay time fluctuates prominently. The structures of the sensing information collecting station 110 and the monitoring center 120 can follow those of the respective embodiments described previously.

FIG. 11 shows an example of a functional block diagram of the router 131-1 of the fourth embodiment. The router 131 of the fourth embodiment includes network interfaces 321 and 322, a transfer signal storing block 302, a priority information extracting block 311, a general information storing block 312, a general information signal transmitting block 313, a priority information storing block 314, a priority information signal transmitting block 315, a transmission control block 316, a control information extracting block 331, a delay information extracting block 333, a rate control block 341, and a parameter control block 351.

The priority information extracting block 311, general information storing block 312, general information signal transmitting block 313, priority information storing block 314, priority information signal transmitting block 315, transmission control block 316, control information extracting block 331, delay information extracting block 333, rate control block 341, and parameter control block 351 of the router 131 of the fourth embodiment each operate in the same way as the priority information extracting block 211, general information storing block 212, general information signal transmitting block 213, priority information storing block 214, priority information signal transmitting block 215, transmission control block 216, control information extracting block 231, delay information extracting block 233, rate control block 241, and parameter control block 251 of the sensing information collecting station 110 according to the first embodiment described previously. The transfer signal storing block 302 operates in the same way as the transfer signal storing block 302 of the router 131 of the third embodiment.

The network interface 321 receives a signal transmitted from the monitoring center 120 toward the sensing information collecting station 110 over the network 130 and outputs it to the transfer signal storing block 302 or the like. The network interface 321 also transmits a signal which has been input from the general information signal transmitting block 313 and the priority information signal transmitting block 315 toward the monitoring center 120 over the network 130. The network interface 322 receives a signal transmitted from the sensing information collecting station 110 toward the monitoring center 120 over the network 130 and outputs it to the priority information extracting block 311. The network interface 322 also transmits a signal which has been input from the transfer signal storing block 302 toward the sensing information collecting station 110 over the network 130.

FIG. 19 is a diagram showing an example of a hardware structure of the router 131-1 according to the fourth embodiment.

The memory module 802-D of the router 131-1 includes a transferring signal storing buffer 3020, a priority information storing buffer 3140, and a general information storing buffer 3120. These buffers correspond to the transfer signal storing block 302, the priority information storing block 314, and the general information storing block 312 shown in FIG. 11, respectively.

The CPU/DSP module 801-D of the router 131-1 executes a predefined program and implements each functional unit shown in FIG. 11. Programs are stored in the memory module 802-D and can be read as appropriate. Other details of the structure are the same as in FIG. 15.

### 5. Others

Division into the functions shown in the embodiments described previously is solely exemplary and other configurations maybe possible if the embodiments of the remote monitoring system, sensing information collecting station, and router can implement equivalent functions in totality.

Although the foregoing embodiments have been described using the terms of priority information/general information, appropriate classification may be adopted not limited to priority/general. For example, the above-mentioned priority information may be first information that is transmitted at a fixed transmission rate and the general information may be second information that is transmitted at a variable rate determined based on a delay time of the first information.

The present invention can be used for, for example, a remote monitoring system in which sensing information measured by sensors and the like is monitored at a monitoring center and for communication apparatus and the like, when using a network operating in a fluctuating communication environment for radio communication or the like.

What is claimed is:

1. A communication apparatus that transmits sensing information measured by sensing terminals and/or statistical information based on the sensing information to a monitoring apparatus via a network, the communication apparatus comprising:
a classification unit that classifies sensing information measured by the sensing terminals and/or statistical information based on the sensing information into first information and second information;
a first information transmitting unit that transmits first information to the monitoring apparatus;
a delay time obtaining unit that measures a delay time to reach first information to the monitoring apparatus across the network or to reach first information across a section of the network or receives the delay time measured by another apparatus;
a rate control block that determines a transmission data rate of second information depending on the delay time, so that the transmission data rate of second information should become smaller when the delay time is larger; and
a second information transmitting unit that transmits second information according to the transmission data rate determined by the rate control block.

2. The communication apparatus according to claim 1, wherein the communication apparatus is a sensing information collecting station that acquires sensing information from one or more of the sensing terminals and transmits the sensing information and/or its statistical information to the monitoring apparatus.

3. The communication apparatus according to claim 1, wherein the communication apparatus is a forwarding apparatus that receives and forwards the sensing information and/or statistical information from a sensing information collecting station that acquires sensing information from one or more of the sensing terminals and transmits the sensing information and/or its statistical information to the monitoring apparatus.

4. The communication apparatus according to claim 1, wherein the first information is priority information that meets a desired priority transmission condition and the second information is non-priority information.

5. The communication apparatus according to claim 4, wherein, if a value of sensing information from the sensing terminals falls within a predetermined range, the sensing information is classified as priority information.

6. The communication apparatus according to claim 4, wherein, statistical information on sensing information from the sensing terminals is classified as priority information and sensing information from the sensing terminals is classified as non-priority information.

7. The communication apparatus according to claim 4, wherein, in response to an increase in a delay time of priority information due to congestion of the network, by decreasing a transmission rate of non-priority information, the delay time of priority information is decreased.

8. The communication apparatus according to claim 4, wherein, the network includes a radio network and, in response to an increase in a delay time of priority information due to a bandwidth fluctuation resulting from a change in a radio environment in the radio network, by decreasing a transmission rate of non-priority information, the delay time of priority information is decreased.

9. The communication apparatus according to claim 2, wherein, the delay time obtaining unit receives from the monitoring apparatus a response signal to first information transmitted by the first information transmitting unit and measures a delay time after transmitting the first information until having received the response signal.

10. The communication apparatus according to claim 9, wherein, it is estimated that the network is in a congested state, when there is a larger difference between a time instant of receiving the response signal and a time instant of transmitting the first information.

11. The communication apparatus according to claim 1, wherein, the first information transmitting unit attaches transmission time instant information to first information and transmits the first information to the monitoring apparatus and the delay time obtaining unit receives a delay time measured on the basis of the transmission time instant information and a time instant of having received the first information and transmitted by the monitoring apparatus or a forwarding apparatus in the network.

12. A communication method in a system where sensing information measured by sensing terminals and/or statistical information based on the sensing information is transmitted to a monitoring apparatus via a network, the communication method comprising:
classifying sensing information measured by sensing terminals and/or statistical information based on the sensing information into first information and second information;
transmitting first information to the monitoring apparatus;
measuring a delay time to reach first information to the monitoring apparatus across the network or to reach first information across a section of the network or receiving the delay time measured by another apparatus;
determining a transmission data rate of second information depending on the delay time, so that the transmission data rate of second information should become smaller when the delay time is larger; and
transmitting second information according to the determined transmission data rate.

13. A remote monitoring system comprising:
a network communication apparatus that collects and transmits sensing information measured by sensing terminals; and
a monitoring apparatus that receives the sensing information and/or statistical information based on the sensing information from the network communication apparatus via a network,
the network communication apparatus comprising:
a classification unit that classifies sensing information from the sensing terminals and/or statistical information based on the sensing information into first information and second information;
a first information transmitting unit that transmits first information to the monitoring apparatus;
a delay time obtaining unit that measures a delay time to reach first information from the network communication apparatus to the monitoring apparatus across the network or to reach first information across a section of the network or receives the delay time measured by another apparatus;
a rate control block that determines a transmission data rate of second information depending on the delay time, so that the transmission data rate of second information should become smaller when the delay time is larger; and
a second information transmitting unit that transmits second information according to the transmission data rate determined by the rate control block.

14. The remote monitoring system according to claim 13,
wherein the first information is priority information and the second information is non-priority information; and
wherein the network communication apparatus and the monitoring apparatus communicates with each other via at least one forwarding apparatus that implements priority control located within the network and the priority information and the non-priority information are handled as those of a same priority class by the forwarding apparatus.
